(19) United States
(12) Patent Application Publication
(10) Pub. No.: US 2012/0169354 A1
(43) Pub. Date: Jul. 5, 2012

(54) FOOD PROBE AND A METHOD FOR RECOGNIZING THE TYPE OF A FOOD AND MONITORING A COOKING PROCESS OF A FOOD STUFF

(75) Inventors: Sebastian Erbe, Eisenach (DE); Florian Ruther, Steinsfeld (DE)

(73) Assignee: ELECTROLUX HOME PRODUCTS CORPORATION N.V., Brussel (BE)

(21) Appl. No.: 13/395,500

(22) PCT Filed: Aug. 16, 2010
(86) PCT No.: PCT/EP2010/005017

§ 371 Date: Mar. 12, 2012

(30) Foreign Application Priority Data
Sep. 18, 2009 (EP) 09011896.9

(51) Int. Cl. G01N 27/02

(52) U.S. Cl. 324/649

(57) ABSTRACT

The present invention relates to a food probe (10) for invading into a food stuff (20). The food probe (10) comprises an elongated rod (12) made of a non-conductive material, a front portion of the elongated rod (12), which front portion is provided for invading into the food stuff (20), a first electrode (14) made of a conductive material and arranged at the front portion of the rod (12), and a second electrode (16) made of a conductive material and arranged at the front portion of the rod (12) in a predetermined distance from the first electrode (14). The first electrode (14) and the second electrode (16) are arranged serially along the longitudinal axis of the rod (12). A voltage can be applied between the first electrode (14) and the second electrode (16), so that an electrical field (22) is generated between and in the environment of the first electrode (14) and the second electrode. Further, the present invention relates to method for recognizing the type of a food and monitoring a cooking process of the food stuff (20) by using the food probe (10).

The present invention relates to a food probe for recognizing the type of a food and monitoring a cooking process of a food stuff. Further, the present invention relates to a method for recognizing the type of a food and monitoring a cooking process of a food stuff.

The cooking process of substantially homogenous food stuffs like meat, potatoes and other vegetables, pies and some casseroles is monitored mainly by detecting the core temperature of the food stuff. The user has to know at which core temperatures the food stuff has certain desired properties like colour, tenderness or degree of cooking.

In order to simplify the cooking process for the user, automatic cooking functions are available. Said cooking functions base on an information input from the user and/or measurements of different sensors like a temperature probe. The determination of food properties by measurements allows a reduction of the information input from the user.

The detection of the electrical impedance of the food stuff can provide a lot of information for the automatic cooking functions.

US 2006/0174775 A1 discloses a method and an apparatus for tracing a cooking process. At least two separated electrodes are inserted into the food stuff. The electrical impedance is measure at a certain frequency in order to monitor the cooking process. However, the type of food stuff cannot be recognized.

It is an object of the present invention to provide a food probe and a method for recognizing the type of the food as well as for monitoring the cooking process of the food stuff.

This object is achieved by the food probe according to claim 1.

According to the present invention the food probe is provided for invading into a food stuff and comprises:
an elongated rod made of a non-conductive material,
a front portion of the elongated rod, which front portion is provided for invading into the food stuff,
a first electrode made of a conductive material and arranged at the front portion of the rod, and
a second electrode made of a conductive material and arranged at the front portion of the rod in a predetermined distance from the first electrode, wherein
the first electrode and the second electrode are arranged serially along the longitudinal axis of the rod, and wherein
a voltage can be applied between the first electrode and the second electrode, so that an electrical field is generated between and in the environment of the first electrode and the second electrode.

The main idea of the invention is the food probe with two serially arranged electrodes at the one rod. Said serially arranged electrodes at the food probe allow the generation of an electrical field in the core of the food stuff. The food probe is a compact tool and easy to handle.

In a preferred embodiment of the present invention the food probe comprises a spike arranged at a front end of the rod. The spike allows an easy invading of the food probe into the food stuff.

Further, the food probe may be connected or connectable to voltage supply and a control circuit of a cooking oven.

In particular, the food probe is provided recognizing the type of the food stuff and monitoring a cooking process of said food stuff.

The object of the present invention is further achieved by the method according to claim 5.

The inventive method for recognizing the type of a food and monitoring a cooking process of a food stuff comprises the steps of:
invading an elongated food probe into the food stuff,
detecting an electrical impedance of the food stuff at two or more frequencies in the beginning of the cooking process,
detecting the electrical impedance of the food stuff at two or more frequencies during the further cooking process, and
comparing the detected values of the electrical impedance with a data base, wherein
the food probe is formed as an elongated rod with at least two electrodes in the front portion of said rod.

The main idea of the inventive method is the detection of the electrical impedance of the food stuff at two or more frequencies. In particular, this additional information allows recognizing the type of a food. The food probe with two arranged electrodes at the one rod is used. Said arranged electrodes at the food probe allow the generation of an electrical field in the core of the food stuff. The food probe is a compact tool and easy to handle.

Preferably, the food probe is invaded into the food stuff in such a way, that the front portion of the rod and the at least two electrodes are arranged within a core of the food stuff.

Additionally, further electrical parameters of the food stuff may be calculated from the electrical impedance. For example, the phase angle, the ohmic resistance and/or the capacity of the food stuff are calculated from the electrical impedance.

In particular, the ratio of phase angle of the electrical impedance at two different frequencies is calculated as a function of the temperature of the food stuff.

For example, one of the different frequencies is 50 kHz or 5 kHz. Preferably, the two different frequencies are 50 kHz and 5 kHz.

Further, the first and/or second derivations of the detected and/or calculated parameters may be determined.

The data base may comprise the frequency spectra of the phase angle of the electrical impedance for a plurality of types of food stuff.

Preferably, the data base can be supplemented by the user. Thus, the user can adapt the data base to individual recipes. Such a teach-in function allows the user a possibility to train the cooking oven for recognizing individual recipes, which are not yet in the data base.

The novel and inventive features believed to be the characteristic of the present invention are set forth in the appended claims.

The invention will be described in further detail with reference to the drawings, in which

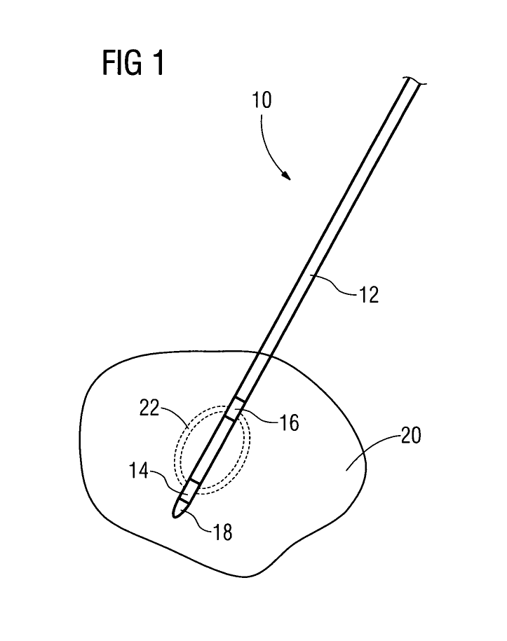

FIG. 1 illustrates a schematic view of a food probe according to a preferred embodiment of the present invention,

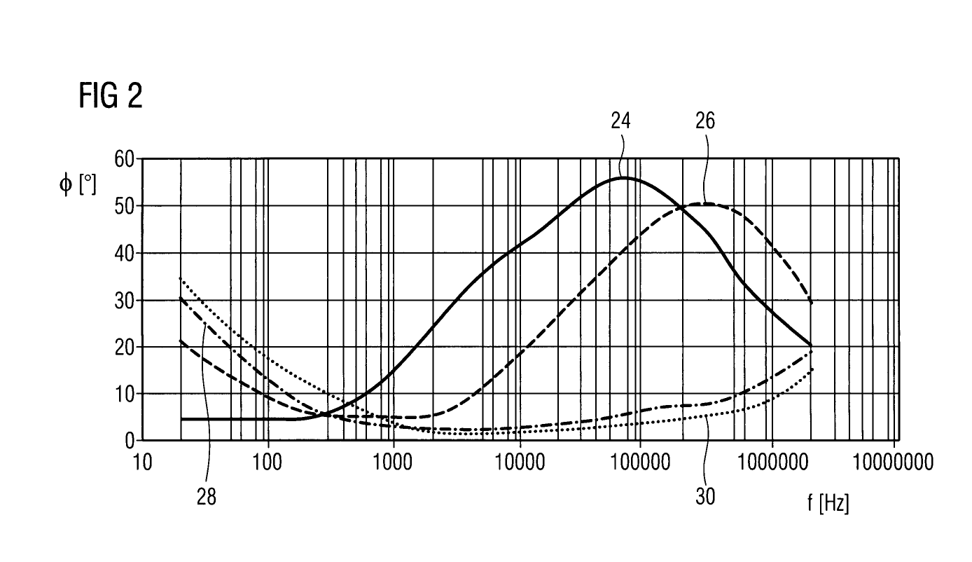

FIG. 2 illustrates a schematic diagram of a phase angle as a function of the frequency for several types of food according to the preferred embodiment of the invention, and

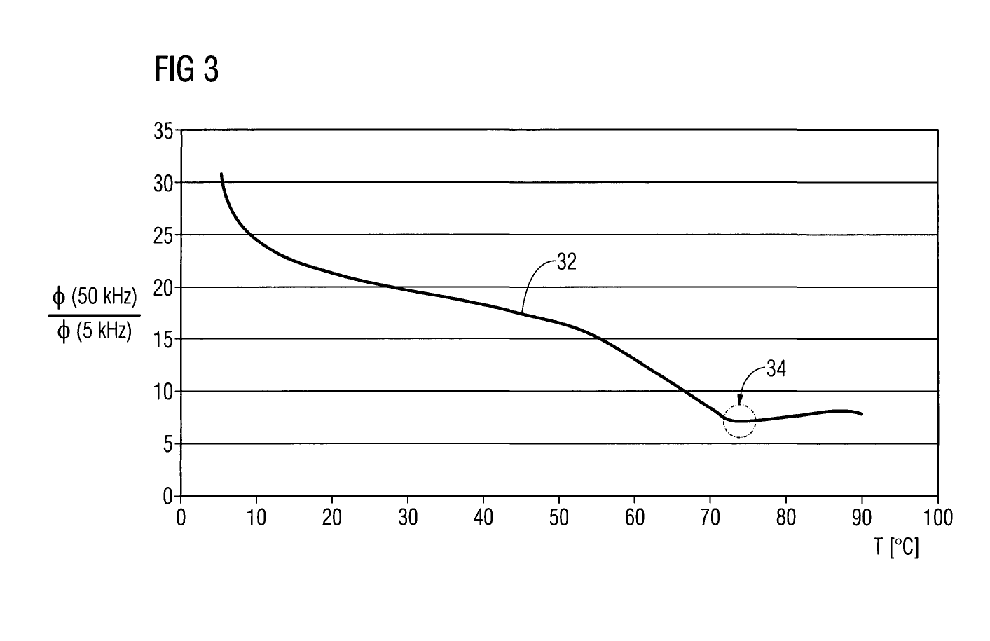

FIG. 3 illustrates a schematic diagram of a ratio of two phase angles at different frequencies as a function of the temperature according to the preferred embodiment of the invention.

FIG. 1 illustrates a schematic view of a food probe 10 according to a preferred embodiment of the present invention. The food probe 10 is provided for recognizing the type of a food and monitoring a cooking process of a food stuff.

The food probe 10 comprises an elongated rod 12, a first electrode 14, a second electrode 16 and a spike 18. A front portion of the food probe 10 is invaded in a food stuff 20.

The rod 12 is made of a non-conductive material. The first electrode 14 and the second electrode 16 are made of a conductive material. The spike 18 is made of a non-conductive material again.

The spike 18 is arranged at a front end of the rod 10. The spike 18 allows that the food probe 10 can easily be invaded into the food stuff 20.

The first electrode 14 and the second electrode 16 are also arranged within the front portion of the rod 12. The first electrode 14 is arranged besides the spike 18. The second electrode 16 is also arranged within the front portion of the rod 12, but in a predetermined distance from the first electrode 14. Thus, the first electrode 14 and the second electrode 16 are electrically isolated from each other.

When the front portion of the food probe 10 is invaded in the food stuff 20, then the first electrode 14 and the second electrode 16 are also arranged within the food stuff 20.

When a voltage is applied between the first electrode 14 and the second electrode 16, then an electric field 22 is generated within the food stuff 20. Said electric field 22 extends between and in the environment of the first electrode 14 and the second electrode 16.

Preferably, the front portion of the food probe 10 is invaded into the food stuff 20 in such a way, that the electric field 22 is generated within the central portion of the food stuff 20.

The serially arranged electrodes at the food probe 10 allow the generation of the electrical field 22 in the core of the food stuff 20. The food probe 10 is a compact tool and easy to handle.

FIG. 2 illustrates a schematic diagram of a phase angle φ as a function of the frequency f for several types of food according to the preferred embodiment of the invention.

A first curve 24 shows the frequency spectrum of the phase angle φ for potatoes. A second curve 26 shows the frequency spectrum of the phase angle φ for cauliflower. A third curve 28 shows the frequency spectrum of the phase angle φ for pork. A fourth curve 30 shows the frequency spectrum of the phase angle φ for the breast of a turkey hen. The spectra of the frequencies in FIG. 2 extend from about 10 Hz to about 1 MHz.

FIG. 2 clarifies that different types of food have their own characteristic phase angles φ as function of the frequency f. The frequency spectrum of the phase angle φ can be detected and compared with a data base. Thus, the type of food can be automatically recognized.

FIG. 3 illustrates a schematic diagram of a ratio of two phase angles φ at different frequencies as a function of the temperature according to the preferred embodiment of the invention. The curve 32 relates to the ratio of the phase angles φ at the frequencies of 50 kHz and 5 kHz. The curve 32 relates to meat.

The spectrum of the temperature in FIG. 3 extends from about 10° C. to about 90° C. At a point 34 the curve 32 has a minimum. At the point 34 all proteins of the food stuff are denaturated, i.e. the meat is fully cooked. The point 34 corresponds with a temperature between 70° C. and 80° C.

Further parameters like resistances, capacities and specific dielectric constants can be calculated from the detected parameters. Additionally, the first and second derivations of the detected and/or calculated parameters can be determined.

In order to obtain more information the temperature of the food stuff 20 can be detected additionally.

A teach-in function can be implemented. Such a teach-in function allows the user a possibility to train the cooking oven for recognizing individual recipes, which are not yet in the data base.

The present invention can also be embedded in a computer program product, which comprises all the features enabling the implementation of the method described herein. Further, when loaded in a computer system, said computer program product is able to carry out these methods.

Although illustrative embodiments of the present invention have been described herein with reference to the accompanying drawing, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 food probe
12 rod
14 first electrode
16 second electrode
18 spike
20 food stuff
22 electric field
24 frequency spectrum of phase angle for potatoes
26 frequency spectrum of phase angle for cauliflowers
28 frequency spectrum of phase angle for pork
30 frequency spectrum of phase angle for turkey
32 ratio of phase angle as function of temperature
34 point where all proteins are denaturated
φ phase angle
f frequency
T temperature

1. A food probe (10) for invading into a food stuff (20) comprising :
an elongated rod (12) made of a non-conductive material, with
a front portion of the elongated rod (12) provided for invading into the food stuff (20),
a first electrode (14) made of a conductive material and arranged at the front portion of the rod (12), and a
second electrode (16) made of a conductive material and arranged at the front portion of the rod (12) at a predetermined distance from the first electrode (14), wherein
the first electrode (14) and the second electrode (16) are arranged serially along the longitudinal axis of the rod (12), and wherein
a voltage can be applied between the first electrode (14) and the second electrode (16) so that an electrical field (22) is generated between and in the environment of the first electrode (14) and the second electrode (16).

2. The food probe according to claim 1, wherein the food probe (10) comprises a spike (18) arranged at a front end of the rod (12).

3. The food probe according to claim 1, wherein the food probe (10) is connected to a voltage supply and a control circuit of a cooking oven.

4. The food probe according to claim 1, wherein the food probe (10) is provided to recognize the type of the food stuff and monitor a cooking process of said food stuff (20) utilizing the electrical field generated in the environment of the first and second electrodes.

5. A method for recognizing the type of a food and monitoring a cooking process of a food stuff (20) comprising the steps of:
invading an elongated food probe (10) into the food stuff (20),
detecting an electrical impedance of the food stuff (20) at two or more frequencies (f) at the beginning of the cooking process,
detecting the electrical impedance of the food stuff (20) at two or more frequencies (f) during the further cooking process, and
comparing the detected values of the electrical impedance with a database, wherein the food probe (10) is formed as an elongated rod (12) with at least two electrodes (14, 16) in the front portion of said rod (12).

6. The method according to claim 5, wherein the food probe (10) is invaded into the food stuff (20) in such a way that the front portion of the rod (12) and the at least two electrodes (14, 16) are arranged within a core of the food stuff (20).

7. The method according to claim 5, wherein further electrical parameters of the food stuff (20) are calculated from the electrical impedance.

8. The method according to claim 7, wherein the further electrical parameters include at least one of a phase angle (φ), an ohmic resistance and a capacity of the food stuff (20).

9. The method according to claim 8, wherein the a ratio of the phase angle (φ) of the electrical impedance at two different frequencies is calculated as a function of a temperature of the food stuff (20).

10. The method according to claim 9, wherein one of the two different frequencies is 50 kHz.

11. The method according to claim 9, wherein one of the two different frequencies is 5 kHz.

12. The method according to claim 7, wherein at least one the first and second derivations of the parameters are determined.

13. The method according to claim 5, wherein the database comprises a frequency spectra of the phase angle (φ) of the electrical impedance for a plurality of types of food stuff (20).

14. The method according to claim 5, wherein the database can be supplemented by a user.
